(19) United States
(12) Patent Application Publication
(10) Pub. No.: US 2026/0338475 A1
(43) Pub. Date: Oct. 29, 2026

(54) HEATING FURNACE AND PRODUCTION SYSTEM

(71) Applicant: JEREH NEW ENERGY TECHNOLOGY CO., LTD., Tianshui (CN)

(72) Inventors: Hongfa CHEN, Tianshui (CN); Shuzhen CUI, Tianshui (CN)

(73) Assignee: JEREH NEW ENERGY TECHNOLOGY CO., LTD., Tianshui (CN)

(21) Appl. No.: 19/205,635

(22) Filed: May 12, 2025

Related U.S. Application Data
(63) Continuation of application No. PCT/CN2025/092083, filed on Apr. 29, 2025.

(51) Int. Cl. F27B 15/14; F27B 15/08; F27B 15/09; F27B 15/16; F27D 11/04

(52) U.S. Cl. CPC F27B 15/14; F27B 15/08; F27B 15/09; F27B 15/16; F27D 11/04; F27M 2001/16

(57) ABSTRACT

A heating furnace and a production system are provided. The heating furnace includes: a furnace body, provided internally with a cavity, where a bottom of the furnace body is provided with a material inlet; and a heating assembly, at least partially arranged in the cavity. The heating assembly has a heating channel in the cavity. A material outlet channel is formed between at least a part of an outer peripheral surface of the heating assembly and an inner surface of the cavity. Both the heating channel and the material outlet channel extend along an extension direction of the cavity. A material inlet port of the heating channel is located at a bottom thereof and is in communication with the material inlet, and a material outlet port of the heating channel is located at a top thereof and is in communication with the material outlet channel.

### CROSS-REFERENCE TO RELATED APPLICATIONS

This application is a continuation of and claims the benefit of priority to PCT International Patent Application PCT/CN2025/092083, filed on Apr. 29, 2025, entitled "HEATING FURNACE AND PRODUCTION SYSTEM," which is herein incorporated by reference in its entirety.

### TECHNICAL FIELD

This application relates to the field of negative electrode material production technologies, and in particular, to a heating furnace and a production system.

### BACKGROUND

With rapid development of energy technologies, batteries have become an indispensable part of human life. A heating furnace is a device that can produce a negative electrode material of a battery. A function of the heating furnace is to transform a carbonaceous material into an artificial graphite material, and performance of the heating furnace is important to the negative electrode material and the battery. However, a current heating furnace, particularly in a high-temperature graphitization process stage, encounters problems such as low production efficiency, high energy consumption, high production costs, and non-uniform material heating temperatures. Therefore, it is particularly important to provide a heating furnace with better performance.

### TECHNICAL PROBLEM

It is necessary to provide a heating furnace and a production system to resolve problems occurring in a current heating furnace such as low production efficiency, high energy consumption, high production costs, and non-uniform material heating temperatures.

### SUMMARY

To achieve the foregoing objective, according to a first aspect, this disclosure provides a heating furnace, including:
a furnace body, provided internally with a cavity, where a bottom of the furnace body is provided with a material inlet; and
a heating assembly, at least partially arranged in the cavity, where the heating assembly has a heating channel in the cavity, a material outlet channel is formed between at least a part of an outer peripheral surface of the heating assembly and an inner surface of the cavity, both the heating channel and the material outlet channel extend along a first direction, and the first direction is an extension direction of the cavity;
where a material inlet port of the heating channel is located at a bottom thereof and is in communication with the material inlet, and a material outlet port of the heating channel is located at a top thereof and is in communication with the material outlet channel.

In some example implementations, the bottom of the furnace body is provided with a material discharge channel, a bottom end of the material outlet channel is in communication with the material discharge channel, and a top end of the material outlet channel is in communication with the material outlet port.

In some example implementations, the material discharge channel has a specific length and is provided with a cooling portion.

In some example implementations, the cooling portion includes a cooling jacket surrounding an outer peripheral surface of the material discharge channel.

In some example implementations, the heating assembly includes a first electrode and a second electrode that extend and are arranged along the first direction, the second electrode is provided with the heating channel, at least a part of the first electrode and at least a part of the second electrode are both arranged in the cavity, the first electrode and the second electrode have opposite polarities and are spaced apart along a second direction, and the second direction is a radial direction of the cavity.

In some example implementations, the heating channel includes a first heating region and a second heating region that are arranged along the first direction, the first heating region is located above the second heating region, a part of the first electrode extends into the heating channel, a first surface of the first electrode and a second surface of the second electrode are arranged opposite to each other along the second direction, and the first heating region is formed between the first surface and the second surface.

In some example implementations, a cross section of the heating channel decreases gradually along a direction from the top of the heating channel to the bottom of the heating channel; both the first heating region and the second heating region are cylindrical, and a cross-sectional diameter of the first heating region is greater than a cross-sectional diameter of the second heating region; or a cross-sectional diameter of the first heating region is greater than a cross-sectional diameter of the second heating region, the heating channel further includes a third heating region, and the third heating region is in a conical shape with a large upper part and a small lower part and is connected between the first heating region and the second heating region.

In some example implementations, the heating furnace further includes a conductive portion, where one end of the conductive portion is connected to a second electrode, and the other end of the conductive portion extends out of the furnace body.

In some example implementations, a chamfer is arranged on an inner sidewall, close to the heating channel, of a top end of the material outlet channel.

In some example implementations, the furnace body includes a thermal insulation layer, a heat preservation layer, and a housing that are arranged from inside out, and the housing is provided with a gas outlet in communication with the cavity.

In some example implementations, a top end of the heating channel is flush with a top end of the material outlet channel and both the top end of the heating channel and the top end of the material outlet channel are in communication with the cavity, and there is a specific interval between the top end of the heating channel and an inner top wall of the cavity.

According to a second aspect, this disclosure further provides a production system, including the heating furnace in any one of the foregoing embodiments.

### BENEFICIAL EFFECTS

In embodiments, the heating furnace uses a lower inlet-lower outlet heating form, which can improve heating efficiency, reduce energy consumption, and further enable heating uniformity of a material to be better and product quality and performance to be superior. In addition, this manner may further reduce a possibility of local high-temperature carbon sublimation caused by flow deviation, thereby enhancing device operational stability, reliability, and safety.

### BRIEF DESCRIPTION OF DRAWINGS

To describe technical solutions in embodiments of this disclosure more clearly, the following briefly describes accompanying drawings. It is clear that the accompanying drawings in the following descriptions show merely some embodiments of this disclosure, and do not constitute an inappropriate limitation on this disclosure. A person skilled in the art may still derive other accompanying drawings from these accompanying drawings without creative efforts. In the accompanying drawings:

FIG. 1 is an example schematic diagram of a structure of a heating furnace according to an embodiment of this disclosure;

FIG. 2 is an example schematic diagram 1 of a structure of a heating assembly according to an embodiment of this disclosure;

FIG. 3 is an example schematic diagram 2 of a structure of a heating assembly according to an embodiment of this disclosure;

FIG. 4 is an example schematic diagram 3 of a structure of a heating assembly according to an embodiment of this disclosure; and

FIG. 5 is an example schematic diagram 4 of a structure of a heating assembly according to an embodiment of this disclosure.

### THE REFERENCE NUMERALS ARE DENOTED AS FOLLOWS

1. material outlet channel;

2. lower electrode (processing portion);

21. first heating region;

22. second heating region;

23. third heating region;

3. overflow port;

4. furnace cover;

5. gas outlet;

6. gas inlet;

7. upper electrode (first electrode);

8. insulation portion;

9. monitoring apparatus;

10. top heat preservation layer;

11. top thermal insulation layer;

12. furnace housing;

13. lateral heat preservation layer;

14. lateral thermal insulation layer;

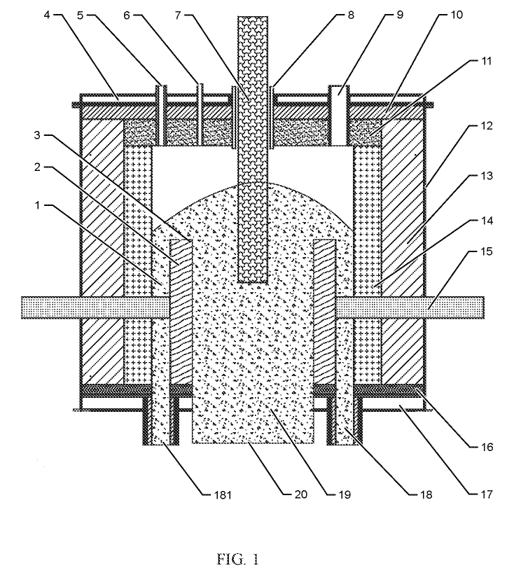

15. conductive portion (In FIG. 1, the processing portion 2 and the conductive portion 15 constitute a second electrode.);

16. bottom thermal insulation layer;

17. water-cooled base;

18. material discharge channel;

19. material;

20. material inlet; and

181. material discharge port.

It should be noted that the elements in the accompanying drawings are exemplary and are not drawn to scale.

### DESCRIPTION OF EMBODIMENTS

The following describes technical solutions in embodiments of this disclosure with reference to FIG. 1 to FIG. 5. It is clear that the described embodiments are merely some but not all of the embodiments of this disclosure. All other embodiments obtained by a person skilled in the art based on the embodiments of this disclosure without creative efforts shall fall within the protection scope of this disclosure.

The "embodiment" mentioned in this specification means that a specific feature, structure, or characteristic described with reference to the embodiment may be included in at least one embodiment of this disclosure. The term appearing at various locations in this specification does not necessarily refer to a same embodiment, or an independent or alternative embodiment mutually exclusive with another embodiment. A person skilled in the art explicitly and implicitly understands that the embodiments described in this specification may be combined with other embodiments.

In the description of this disclosure, it should be understood that if terms such as "center", "longitudinal", "transverse", "length", "width", "thickness", "upper", "lower", "front", "rear", "left", "right", "vertical", "horizontal", "top", "bottom", "inner", "outer", "clockwise", "counterclockwise", "axial", "radial", and "circumferential" are used, an orientation or positional relationship indicated by these terms is an orientation or positional relationship shown based on the accompanying drawings, and is merely for the purpose of facilitating the description of this disclosure and simplifying the description, rather than indicating or implying that a referred apparatus or element must have a specific orientation or be constructed and operated in a specific orientation. Therefore, such terms should not be construed as limitations on this disclosure.

If the terms "first" and "second" are used, these terms are intended for description purposes only, and should not be understood as indicating or implying relative importance or implicitly indicating the quantity of indicated technical features. Therefore, a feature defined with "first" or "second" may explicitly or implicitly include at least one of such features.

If there is a term "a plurality of", the meaning of "a plurality of" is "at least two", for example, two or three, unless otherwise explicitly and specifically defined.

In this disclosure, unless otherwise explicitly specified and defined, if the terms such as "mount", "interconnect", "connect", and "fix" appear, these terms shall be understood in a broad sense, for example, may be a fixed connection, a detachable connection, or an integral connection; may be a mechanical connection or an electrical connection; may be a direct connection or an indirect connection through an intermediate medium; or may be communication between insides of two elements or an interaction relationship between two elements, unless otherwise explicitly defined. A person of ordinary skill in the art may understand specific meanings of the foregoing terms in this disclosure based on specific situations.

In this disclosure, unless otherwise explicitly specified and defined, if there are descriptions such as a first feature being "above" or "below" a second feature or similar expressions, the meaning thereof may be that the first and second features are in direct contact, or that the first and second features are in indirect contact through an intermediate medium. In addition, the first feature being "over", "above", and "on" the second feature may be that the first feature is directly above or obliquely above the second feature, or merely indicates that a horizontal height of the first feature is higher than that of the second feature. The first feature being "under", "below", and "beneath" the second feature may be that the first feature is directly below or obliquely below the second feature, or merely indicates that a horizontal height of the first feature is lower than that of the second feature.

It should be noted that if an element is referred to as being "fixed to" or "arranged on" another element, the element may be directly located on the another element, or there may be an element therebetween. If an element is considered as being "connected to" another element, the element may be directly connected to the another element, or there may be an element therebetween. The terms, if any, "vertical", "horizontal", "top", "bottom", "inner", "outer", "left", "right", and similar expressions are used in this disclosure for illustrative purposes only and do not indicate an only possible implementation.

This disclosure relates to a heating furnace, and the heating furnace may transform carbon atoms from a turbostratic structure to an ordered graphite crystal structure through heating, to implement graphitization processing of non-graphite carbon. Graphitization serves to improve thermal and electrical conductivity of a carbon material, enhance thermal shock resistance and chemical stability of the carbon material, impart lubricity and wear resistance to the carbon material, enhance purity of the carbon material, and so on.

Currently, the heating furnace may be mainly used for sintering and graphitization of a carbon material, graphitization of a polyimide film (PI), graphitization of a thermally conductive material, sintering of a carbon fiber rope, sintering and graphitization of a carbon fiber filament, graphite purification, and high-temperature processing of another material or the like graphitizable in a carbon environment. In some embodiments, a graphite material processed by the heating furnace may be used to form a negative electrode material of a battery. For example, graphite may be used as a main negative electrode material of a current lithium battery. Through graphitization, the negative electrode material can significantly improve performance indicators such as a specific capacity, initial efficiency, a specific surface area, compaction density, conductivity, and chemical stability of the negative electrode material.

In this embodiment, a battery refers to a physical module that includes one or more battery cells to provide electric energy. The battery generally includes a case for packaging one or more battery cells. In some example implementations, the battery cell may include a lithium-ion secondary battery, a lithium-ion primary battery, a lithium-sulfur battery, a sodium-lithium-ion battery, a sodium-ion battery, or a magnesium-ion battery. This is not limited in the embodiments of this disclosure. Graphite may be used as a negative electrode active material of the battery cell, and may cooperate with a positive electrode active material (for example, lithium cobaltate, lithium iron phosphate, ternary lithium, or lithium manganate) of the battery cell to implement movement of metal ions to form a current.

In some related designs of the heating furnace, a positive electrode and a negative electrode are arranged in the heating furnace. One end of each of the positive electrode and the negative electrode is connected to a direct-current power supply or an alternating-current power supply, and the other end of the positive electrode and the other end of the negative electrode are arranged opposite to each other, so that an electric field is formed between the positive electrode and the negative electrode. When a carbonaceous material entering the heating furnace passes through the electric field, the carbonaceous material is electrified, and the carbonaceous material may be heated through a resistor thereof to reach a graphitization temperature, thereby implementing transformation for graphitization.

In a design of the heating furnace, a material inlet port of a heating channel is located at a bottom, and a material outlet port is located at a top of the heating channel, that is, a lower inlet-lower outlet heating form is used, to improve heating efficiency, reduce energy consumption, and further enable heating uniformity of a material to be better and product quality and performance to be superior. In addition, this manner may further reduce a possibility of local high-temperature carbon sublimation caused by flow deviation, thereby enhancing device operational stability, reliability, and safety.

In some specific implementations, a bottom of a furnace body is provided with a material discharge channel, a bottom end of a material outlet channel is in communication with the material discharge channel, a top end of the material outlet channel is in communication with the material outlet port of the heating channel, and the material discharge channel has a specific length and the material discharge channel is provided with a cooling portion. In this implementation, the material overflowing from the heating channel enters the material outlet channel, and then the material in the material outlet channel passes through the material discharge channel and is discharged through a material discharge port of the material discharge channel. In this process, the cooling portion on the material discharge channel further cools the material in the material discharge channel, to achieve a better cooling effect.

In some specific implementations, the negative electrode is of a three-dimensional annular structure, the positive electrode is of a columnar structure, and a part of the positive electrode extends into the negative electrode, so that the positive electrode and the negative electrode are arranged opposite to each other, and a stable electric field is formed between opposite surfaces of the positive electrode of the columnar structure and the negative electrode of the annular structure. In this implementation, because a coverage area of the electric field is large, when power supply powers received by the electrodes are constant, electric field energy generated by the electrodes per unit volume is large, that is, energy density of the electric field is large, thereby improving quality and production efficiency of a graphitized material.

In view of this, this disclosure provides a new heating furnace. In embodiments, the heating furnace includes a furnace body and a heating assembly. The furnace body is provided internally with a cavity. A bottom of the furnace body is provided with a material inlet. At least a part of the heating assembly is arranged in the cavity and the heating assembly located in the cavity has a heating channel. A material outlet channel is formed between at least a part of an outer peripheral surface of the heating assembly and an inner surface of the cavity. Both the heating channel and the material outlet channel extend along a first direction (that is, an extension direction of the cavity). A material inlet port of the heating channel is located at a bottom thereof and is in communication with the material inlet. A material outlet port of the heating channel is located at a top thereof and is in communication with the material outlet channel.

In embodiments, on the one hand, the heating channel has a small spatial volume that accommodates a small quantity of materials within a same period of time. Compared with a solution in a related technology that a heating assembly needs to heat a material in an entire furnace body, this embodiment features higher heating power density for heating the material in the heating channel, a higher material heating speed, and more uniform material heating, thereby reducing a possibility of local high-temperature carbon sublimation caused by flow deviation. On the other hand, compared with the solution in the related technology that the material enters the furnace body from a top and is output from a bottom, this embodiment implements that the material enters from the bottom and is output from the bottom, which can ensure that material heating is more uniform, the material flows in the heating channel and the material outlet channel, a flow path of the material is longer, the material is heated for a longer time at a high temperature in the furnace body, and the material can make full use of heat in the furnace body, thereby improving utilization of the heat in the furnace body, and improving energy utilization of the entire heating furnace. In other words, the lower inlet-upper outlet heating form in this embodiment can reduce the possibility of local high-temperature carbon sublimation caused by flow deviation, thereby enhancing device operational stability, reliability, and safety. In addition, this manner may further enable heating uniformity of the material to be better and product quality and performance to be superior.

The heating furnace in this embodiment may be applied to any graphite production system, for example, a sintering and graphitization system for a carbon material, a PI film graphitization system, a thermally conductive material graphitization system, a sintering and graphitization system for a carbon fiber rope/carbon fiber filament, or a graphite purification system. This disclosure sets no limitation on a specific application scenario of the heating furnace.

In an example, a graphite material generated by the heating furnace may be used as a negative electrode material of a battery. To be specific, in this embodiment, the heating furnace may be applied to a battery production system. The heating furnace may be used as a process device in a battery production line.

This disclosure provides a heating furnace, including a furnace body and a heating assembly. The furnace body is provided internally with the cavity. The bottom of the furnace body is provided with the material inlet. At least a part of the heating assembly is arranged in the cavity and the heating assembly located in the cavity has the heating channel. The material outlet channel is formed between at least a part of the outer peripheral surface of the heating assembly and the inner surface of the cavity. Both the heating channel and the material outlet channel extend along the first direction (that is, the extension direction of the cavity). Specifically, the material inlet port of the heating channel is located at the bottom thereof and is in communication with the material inlet, and the material outlet port of the heating channel is located at the top thereof and is in communication with the material outlet channel.

The lower inlet-upper outlet heating form is used, which can improve heating efficiency of the material, reduce energy consumption, and further enable heating uniformity of the material to be better and product quality and performance to be superior. In addition, this manner may further reduce the possibility of local high-temperature carbon sublimation caused by flow deviation, thereby enhancing device operational stability, reliability, and safety.

An embodiment of this disclosure provides a vertical heating furnace. A heating form may be resistance heating, natural gas heating, electromagnetic induction heating, or the like. This is not limited in this disclosure.

FIG. 1 is an example schematic diagram of a structure of a heating furnace according to an embodiment of this disclosure. In this embodiment, a heating form is resistance heating. The heating furnace in this embodiment includes a furnace body, a furnace cover 4, a material inlet 20, an upper electrode (that is, a first electrode) 7, a processing portion 2, a conductive portion 15 (in this embodiment, the processing portion 2 and the conductive portion 15 constitute a second electrode), and a material discharge channel 18. Both the material inlet 20 and the material discharge channel 18 are arranged at a bottom of the furnace body. The furnace body includes a thermal insulation layer, a heat preservation layer, and a furnace housing that are arranged from inside out.

It can be understood that the first electrode and the second electrode are of two electrode structures with opposite polarities. When the first electrode is of a positive electrode structure or an anode structure, the second electrode is of a negative electrode structure or a cathode structure. Alternatively, when the first electrode is of a negative electrode structure or a cathode structure, the second electrode is of a positive electrode structure or an anode structure. When the first electrode and the second electrode are electrified, the heating channel between the first electrode and the second electrode forms an electric field. A conductive material can be heated under the action of a current when flowing in the heating channel. Compared with a solution of heating a material by using an auxiliary material, heating efficiency of the conductive material through spontaneous heating is higher. In some examples, the heating furnace may implement, without limitation, application scenarios of material heating at 1,000°C, 2,000°C, and even more than 2,500°C.

Specifically, there may be one or more first electrodes. This is not limited in this disclosure.

Specifically, the furnace body has a cylindrical cavity, at least a part of the upper electrode 7 and at least a part of the processing portion 2 are both arranged in the cavity, and the upper electrode and the processing portion have opposite polarities and are spaced apart along a second direction (that is, a radial direction of the cavity).

For example, the processing portion 2 is in an annular shape, an inner side of the processing portion 2 is enclosed to form the heating channel and the material outlet channel 1 is formed through enclosure between an outer peripheral surface of the processing portion 2 and a thermal insulation layer.

Specifically, a diameter of the upper electrode 7 may be less than a diameter of an inner wall of the processing portion 2, and a diameter of an outer wall of the processing portion 2 is less than a diameter of an inner wall of a lateral thermal insulation layer 14. The upper electrode 7 may be made of graphite. The conductive portion 15 may be a conductive medium and may be used for an electrical connection or current conduction function component or region. A material of the conductive portion 15 may be a graphite electrode, or may be another conductive substance. The graphite material has low resistivity, can conduct a current efficiently, and has good thermal conductivity, thereby rapidly transferring heat, and achieving a better material heating effect.

Graphite materials include but are not limited to ordinary graphite, high-power graphite, and ultra-high-power graphite. The processing portion 2 may be made of a high-temperature resistant material, including but not limited to graphite, a carbon-carbon material, and the like.

Further, a cross section of the upper electrode 7 may be in a circular shape, a cross section of the processing portion 2 may be in a circular, square, or another shape, and there may be one or more processing portions 2.

The heating channel may be a vertically penetrated cylindrical channel, and the material outlet channel 1 may be an annular channel surrounding a periphery of the heating channel. A bottom end of the heating channel may be a material inlet port thereof, which is directly connected to the material inlet 20 of the furnace body. A top end of the heating channel may be a material outlet port thereof, which is flush with a top end of the material outlet channel 1. A bottom end of the material outlet channel 1 may be a material outlet port thereof, which is in communication with the material discharge channel. In this way, a material overflowing from the heating channel may enter the material outlet channel 1, enter the material discharge channel from the bottom end of the material outlet channel 1 under the action of gravity, and be discharged out of the furnace body.

In this disclosure, the terms "upper" or "top" refers to a direction opposite to the gravity, and the terms "lower" or "bottom" refers to a direction along the gravity.

It can be understood that, in some examples, the material may have an initial speed when entering the heating channel from the material inlet 20 at the bottom, so that the material can move upward along the heating channel. In some other examples, some devices that can drive the material to move upward from the bottom of the furnace body are further included inside or outside the furnace body. A specific manner in which the material moves upward along the heating channel is not limited in this embodiment of this disclosure.

The heating furnace in this embodiment of this disclosure is of a vertical structure that performs feeding by using the gravity. The material discharge channel and a subsequent cooling system are both arranged below the furnace, and the heating furnace may be mounted at a height. In this way, the heating furnace has a small footprint, thereby improving land utilization efficiency. In addition, a feeding arrangement may be placed next to the heating furnace for continuously feeding, so that material feeding is more uniform, thereby facilitating industrial production, and saving land resources.

For example, the thermal insulation layer includes a lateral thermal insulation layer 14, a top thermal insulation layer 11, and a bottom thermal insulation layer 16; a heat preservation layer includes a lateral heat preservation layer 13 and a top heat preservation layer 10. The lateral heat preservation layer 13 may be arranged on an outer side of the lateral thermal insulation layer 14, the top heat preservation layer 10 may be arranged on an upper side of the top thermal insulation layer 11, and the furnace cover 4 may be arranged on an upper side of the top heat preservation layer 10. The bottom thermal insulation layer 16 may be located at an upper part of a water-cooled base 17 of the furnace body. The bottom thermal insulation layer 16 may be made of a refractory material, a heat preservation material, or a graphite material.

In some other embodiments, the heat preservation layer may alternatively not be arranged. In other words, the heat preservation layer may be configured according to a heating requirement.

For example, the thermal insulation layer is made of a high-temperature resistant material, including but not limited to a carbon brick, a graphite material, and a carbon-carbon material; and the heat preservation layer may be made of a high-temperature resistant material, including but not limited to one of or a combination of several of carbon black, a graphite felt, a carbon felt, a heat preservation cotton, a heat preservation brick, a ceramic fiber plate, or a cast masonry.

An outermost layer of the heat preservation layer may be the furnace housing 12. In some embodiments, the furnace housing 12 is of a structure formed by an independent steel plate or a cast masonry. Alternatively, in some other embodiments, the furnace housing 12 may be a water-cooled jacket enclosed by two layers of steel plates or a water-cooled jacket formed by processing a half-round pipe on an outer surface of a steel plate, thereby reducing a surface temperature of the furnace housing 12, and preventing a person from being scalded and avoiding another hazardous incident.

For example, an outer wall of the furnace cover 4 may be an independent steel plate, a water-cooled jacket enclosed by two layers of steel plates, or a water-cooled jacket formed by processing a half-round pipe on an outer surface of a steel plate.

Referring to FIG. 1, the upper electrode 7 sequentially passes through the furnace cover 4, the top heat preservation layer 10, and the top thermal insulation layer 11, and comes into contact with a material 19 during operating. The material 19 includes a granular material, a powder material, or a mixture thereof. To avoid a current short circuit caused by direct contact between the upper electrode 7 and conductive portions such as the furnace cover 4 and the top thermal insulation layer 11 in the furnace body, an insulation portion 8 may be arranged. Specifically, the insulation portion 8 may be a circular ring running through the furnace cover 4, the top heat preservation layer 10, and the top thermal insulation layer 11, and the upper electrode 7 may extend into the cavity of the furnace body through the insulation portion 8. The upper electrode 7 may be located above the processing portion 2 during operating, or may be inserted into the heating channel of the processing portion 2, that is, located below an overflow port 3. The overflow port 3 may be the material outlet port of the heating channel. In this implementation, the overflow port may be a location at which the material is beyond a top surface of the processing portion 2. A specific depth of the upper electrode 7 in the heating channel is related to a temperature at which the material needs to be heated.

For example, the processing portion 2 is connected to a power supply apparatus through the conductive portion 15, a location of the conductive portion 15 may be located at the bottom or a side surface of the furnace body.

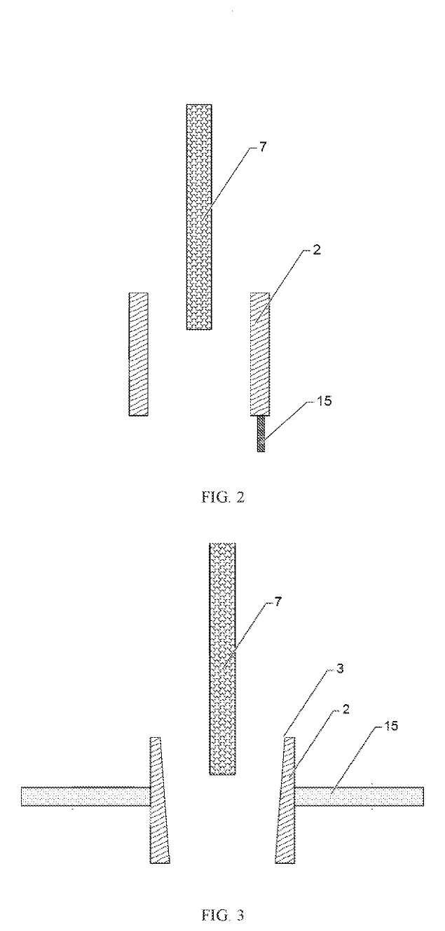

Specifically, the conductive portion 15 may be columnar, and is connected to the processing portion 2 through the furnace body (as shown in FIG. 1). Alternatively, in some other embodiments, as shown in FIG. 2, the conductive portion 15 may be arranged at the bottom, runs through a bottom end of the furnace body, and is connected to a negative current terminal of a transformer.

Specifically, the material 19 enters the heating channel from the material inlet 20. The upper electrode 7 may be located at a center location of the processing portion 2. When the upper electrode 7 and the processing portion 2 are electrified, a current may pass through the material in the processing portion 2, to implement resistance heating of the material. The material may overflow from an upper part of the processing portion 2 after being heated in the processing portion 2. The overflowed material may enter the material outlet channel 1, pass through the material outlet channel 1 and the material discharge channel 18, and then may be discharged from a material discharge port 181. For example, the material discharge channel 18 may be cooled by using a cooling portion (for example, the water-cooled jacket).

For example, the furnace cover 4 may be provided with a gas outlet 5. Specifically, both the material inlet 20 and the material discharge port 181 may be located at a lower part of the furnace body, and a material inlet direction may be opposite to a material outlet direction. Ash and a volatile matter generated by heating the material may be discharged through the gas outlet 5 located at a top of the furnace cover. There may be one or more gas outlets 5. There may be one or more material discharge ports 181. The material discharge port 181 may be an annular, circular, or square opening. When there are a plurality of material discharge ports 181, the material discharge ports 181 surrounding the material inlet 20 may be preferentially uniformly distributed circumferentially.

For example, the furnace cover 4 may be provided with a monitoring apparatus 9 and an inert gas inlet 6. An inert gas, such as nitrogen or argon, may be introduced from a top of the furnace cover 4, thereby reducing a temperature of the furnace cover, discharging the ash and the volatile matter generated during heating, maintaining a pressure inside the furnace, maintaining an anoxic state in the furnace body, and preventing performance of the material from being affected by oxidation of the material.

Referring to FIG. 2 to FIG. 5, the processing portion may alternatively be in a different form. Specifically, a structure of the processing portion 2 may be a cylindrical or conical structure, or the processing portion 2 may be of a structure with a diameter becoming larger or being equal from the material inlet port 20 to the overflow port 3.

FIG. 3 shows an embodiment in which an angle is formed between an inner wall of the processing portion 2 and a central line of the upper electrode 7. In this embodiment, a diameter of the inner wall gradually increases from bottom to top.

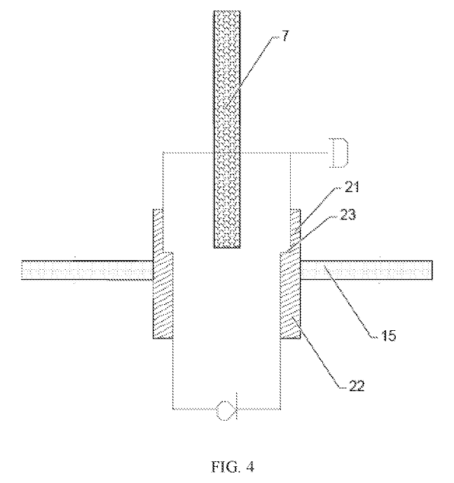

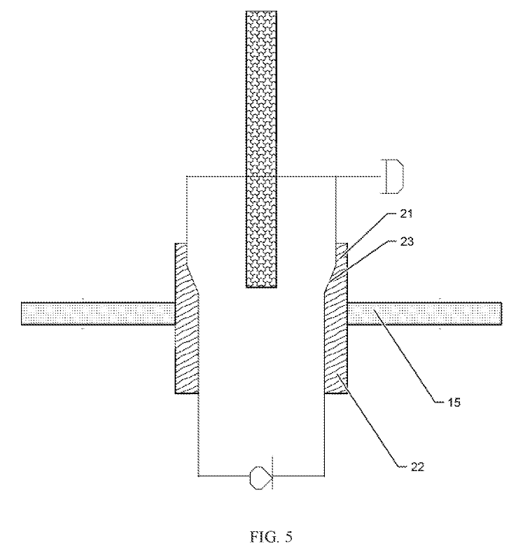

FIG. 4 shows another form of the processing portion 2. In this embodiment, the upper half part and a lower half part of the inner wall of the processing portion 2 are both cylindrical, but a diameter D of the upper half part of the inner wall ≥ a diameter d of the lower half part of the inner wall. The upper half part is a first heating region 21, and the lower half part is a second heating region 22. Further, a contact region between the upper half part and the lower half part of the inner wall of the processing portion 2 is defined as a transition part. Herein, the contact region may be a right-angle transition (that is, a form shown in FIG. 4), or may be a bevel transition (that is, a form shown in FIG. 5). The bevel transition part is a third heating region, so that the material can enter the upper heating region more evenly from the lower heating region.

A lower inlet-upper outlet heating form in this implementation can reduce a possibility of local high-temperature carbon sublimation caused by flow deviation, thereby enhancing device operational stability, reliability, and safety, improving heating efficiency of the material, and enabling heating uniformity of the material to be better and product quality and performance to be superior.

The technical features in the foregoing embodiments may be arbitrarily combined. To make the description brief, not all possible combinations of the technical features in the foregoing embodiments are described. However, the combinations of the technical features should be considered as falling within the scope described in this specification provided that there is no contradiction between these combinations.

The foregoing embodiments represent only several implementations of this application, and description thereof is relatively specific and detailed, but should not be construed as a limitation on the scope of this application. It should be noted that a person of ordinary skill in the art may make some variations and improvements without departing from the concept of this application, and all of these variations and improvements fall within the protection scope of this application. Therefore, the protection scope of this application shall be subject to the appended claims.

What is claimed is:

1. A heating furnace comprising:
a furnace body, provided internally with a cavity, wherein a bottom of the furnace body is provided with a material inlet; and
a heating assembly, at least partially arranged in the cavity, wherein the heating assembly comprises a heating channel in the cavity, a material outlet channel is formed between at least a part of an outer peripheral surface of the heating assembly and an inner surface of the cavity, both the heating channel and the material outlet channel extend along a first direction, and the first direction represents an extension direction of the cavity,
wherein:
a material inlet port of the heating channel is located at a bottom thereof and is in communication with the material inlet, and
a material outlet port of the heating channel is located at a top thereof and is in communication with the material outlet channel.

2. The heating furnace according to claim 1, wherein:
the bottom of the furnace body is provided with a material discharge channel;
a bottom end of the material outlet channel is in communication with the material discharge channel; and
a top end of the material outlet channel is in communication with the material outlet port of the heating channel.

3. The heating furnace according to claim 2, wherein the material discharge channel has a specific length and is provided with a cooling portion.

4. The heating furnace according to claim 3, wherein the cooling portion comprises a cooling jacket surrounding an outer peripheral surface of the material discharge channel.

5. The heating furnace according to claim 1, wherein:
the heating assembly comprises a first electrode and a second electrode that extend and are arranged along the first direction;
the second electrode is provided with the heating channel;
at least a part of the first electrode and at least a part of the second electrode are both arranged in the cavity;
the first electrode and the second electrode have opposite polarities and are spaced apart along a second direction; and
the second direction represents a radial direction of the cavity.

6. The heating furnace according to claim 5, wherein:
the heating channel comprises a first heating region and a second heating region that are arranged along the first direction;
the first heating region is located above the second heating region;
a part of the first electrode extends into the heating channel;
a first surface of the first electrode and a second surface of the second electrode are arranged opposite to each other along the second direction; and
the first heating region is formed between the first surface and the second surface.

7. The heating furnace according to claim 6, wherein:
a cross section of the heating channel decreases gradually along a direction from the top of the heating channel to the bottom of the heating channel;
both the first heating region and the second heating region are cylindrical; and
a cross-sectional diameter of the first heating region is greater than a cross-sectional diameter of the second heating region.

8. The heating furnace according to claim 6, wherein:
a cross section of the heating channel decreases gradually along a direction from the top of the heating channel to the bottom of the heating channel;
a cross-sectional diameter of the first heating region is greater than a cross-sectional diameter of the second heating region;
the heating channel further comprises a third heating region; and
the third heating region is in a conical shape with a large upper part and a small lower part and is connected between the first heating region and the second heating region.

9. The heating furnace according to claim 1, further comprising a conductive portion, wherein one end of the conductive portion is connected to a second electrode, and the other end of the conductive portion extends out of the furnace body.

10. The heating furnace according to claim 1, wherein a chamfer is arranged on an inner sidewall, close to the heating channel, of a top end of the material outlet channel.

11. The heating furnace according to claim 1, wherein:
the furnace body comprises a thermal insulation layer, a heat preservation layer, and a housing that are arranged from inside out; and
the housing is provided with a gas outlet in communication with the cavity.

12. The heating furnace according to claim 1, wherein:
a top end of the heating channel is flush with a top end of the material outlet channel;
both the top end of the heating channel and the top end of the material outlet channel are in communication with the cavity; and
the top end of the heating channel and an inner top wall of the cavity are spaced by an interval.

13. A production system comprising the heating furnace according to claim 1.
